(19) United States
(12) Patent Application Publication
(10) Pub. No.: US 2022/0020041 A1
(43) Pub. Date: Jan. 20, 2022

(54) DISCOUNT PERCENTAGE DETERMINATION SYSTEM, DISCOUNTED PRICE PRESENTATION SYSTEM, DISCOUNT PERCENTAGE DETERMINATION METHOD, AND STORAGE MEDIUM

(71) Applicant: Toyota Jidosha Kabushiki Kaisha, Toyota-shi Aichi-ken (JP)

(72) Inventors: Masahiro Nishiyama, Toyota-shi (JP); Kenji Tsukagishi, Toyota-shi (JP); Takahisa Kaneko, Toyota-shi (JP); Erina Kigoshi, Tokyo (JP); Aiko Miyamoto, Toyota-shi (JP)

(73) Assignee: Toyota Jidosha Kabushiki Kaisha, Toyota-shi Aichi-ken (JP)

(21) Appl. No.: 17/324,802

(22) Filed: May 19, 2021

(30) Foreign Application Priority Data
Jul. 15, 2020 (JP) 2020-121137

(51) Int. Cl. G06Q 30/02

(52) U.S. Cl. CPC G06Q 30/0205; G06Q 30/0211; G06K 9/325; G06Q 30/0224; G06Q 30/0206

(57) ABSTRACT

A discount percentage determination system includes: an information acquisition unit configured to acquire, from a database in which residential areas and electronic payment information of consumers who made electronic payments are recorded in association with each other, the electronic payment information for each of the residential areas; and a discount percentage determination unit configured to identify a tendency of the electronic payments for each of the residential areas based on the electronic payment information for each of the residential areas and to determine for each of the residential areas a discount percentage for prices of items for sale at a predetermined store according to the identified tendency.

### CROSS-REFERENCE TO RELATED APPLICATIONS

This application claims priority to Japanese Patent Application No. 2020-121137 filed on Jul. 15, 2020, which is incorporated herein by reference including the specification, drawings and abstract.

### BACKGROUND

### 1. Technical Field

The present disclosure relates to discount percentage determination systems for determining a discount percentage for items for sale such as goods or services sold at a predetermined store, discounted price presentation systems, discount percentage determination methods, and storage media.

### 2. Description of Related Art

Japanese Unexamined Patent Application Publication No. 2018-10340 (JP 2018-10340 A) discloses a discount system for discounting the parking fee for a user who purchased an item for sale such as a product or service sold at a store, based on information on the amount paid for the item.

### SUMMARY

Although the discount system of JP 2018-10340 A discounts the parking fee, there are cases where it is desired to attract consumers to a store by discounting the prices of items for sale at the store. One way to discount the prices of items for sale is to apply the same discount percentage to each consumer. However, for example, there are cases where it is desired to preferentially attract consumers living in a certain area to the store by dividing the area according to the frequency of visits of consumers to the store. In this case, it is not effective to apply the same discount percentage to each consumer as described above.

The present disclosure provides a discount percentage determination system, a discounted price presentation system, a discount percentage determination method, and a storage medium that can preferentially attract consumers living in a certain area to a store.

A first aspect of the present disclosure relates to a discount percentage determination system. The discount percentage determination system includes: an information acquisition unit configured to acquire, from a database in which residential areas and electronic payment information of consumers who made electronic payments are recorded in association with each other, the electronic payment information for each of the residential areas; and a discount percentage determination unit configured to identify a tendency of the electronic payments for each of the residential areas based on the electronic payment information for each of the residential areas and to determine for each of the residential areas a discount percentage for prices of items for sale at a predetermined store according to the identified tendency.

According to the first aspect, the discount percentage is determined for each of the residential areas according to the tendency of the electronic payments for each of the residential areas identified based on the database including the residential areas and the electronic payment information of the consumers who made the electronic payments. Accordingly, consumers living in a residential area with a high discount percentage are more motivated to visit the store. Accordingly, it is possible to preferentially attract consumers living in a certain area to the store.

In the first aspect, the tendency of the electronic payments may be a total or an average of amounts paid by the electronic payments made within a certain period. The discount percentage determination unit may be configured to determine the discount percentage according to the total or the average.

According to the above configuration, for example, a high discount percentage can be set for a residential area whose total or average of the amounts paid by the electronic payments made within the certain period is within a predetermined range. This can attract more customers living in this residential area to the store and can increase the sales of the store. For example, it can be said that consumers living in a residential area with a high average amount tend to pay a large amount of money per purchase at the store. Accordingly, setting a high discount percentage for the residential area with a high average amount can attract more consumers living in this residential area to the store and can further increase the sales of the store. It can also be said that consumers living in a residential area with a small average amount tend to pay a small amount of money per purchase at the store. Accordingly, setting a high discount percentage for the residential area with a small average amount can attract more consumers living in this residential area to the store. This can cover the low purchase amount by the number of consumers visiting the store and can increase the sales of the store.

In the above aspect, the tendency of the electronic payments may be the number of the electronic payments made within a certain period. The discount percentage determination unit may be configured to determine the discount percentage according to the number of the electronic payments.

According to the above configuration, for example, a high discount percentage can be set for a residential area whose number of electronic payments made within the certain period is within a predetermined range. This can attract more customers living in this residential area to the store and can increase the sales of the store. For example, it can be said that consumers living in a residential area with a large number of electronic payments tend to visit the store more frequently. Accordingly, setting a high discount percentage for the residential area with a large number of electronic payments can further increase the frequency of visits of consumers living in this residential area to the store and can further increase the sales of the store. It can also be said that consumers living in a residential area with a small number of electronic payments tend to visit the store less frequently. Accordingly, setting a high discount percentage for the residential area with a small number of electronic payments can increase the frequency of visits of consumers living in this residential area to the store and can increase the sales of the store.

In the above aspect, the discount percentage determination system may be configured to determine the discount percentage for each of residential areas of a consumer who is going to purchase the items such that the prices of the items are discounted according to the residential area of the consumer who is going to purchase the items.

A second aspect of the present disclosure relates to a discounted price presentation system. The discounted price presentation system includes: the discount percentage determination system according to the above aspect; a residential area identification unit configured to identify a residential area of a consumer who is going to purchase items for sale; and a presentation unit configured to present the prices of the items discounted at the discount percentage determined for the residential area of the consumer, to the consumer.

According to this configuration, the prices discounted at the discount percentage for the residential area can be presented to the consumer and the customer's motivation to purchase at the store can be improved.

In the second aspect, the residential area of the consumer may be a place name displayed on a license plate of a vehicle of the consumer. The residential area identification unit may be configured to acquire a captured image of the license plate, and process the acquired captured image to identify the place name.

Accordingly, when, for example, purchasing food and drink at a drive-through, the consumer can be presented with the prices discounted at the discount percentage for the residential area of the consumer without performing an operation of entering the residential area. The convenience of the consumer is thus improved.

A third aspect of the present disclosure relates to a discount percentage determination method. The discount percentage determination method includes: acquiring, from a database in which residential areas and electronic payment information of consumers who made electronic payments are recorded in association with each other, the electronic payment information for each of the residential areas; and identifying a tendency of the electronic payments for each of the residential areas based on the electronic payment information for each of the residential areas and determining for each of the residential areas a discount percentage for prices of items for sale at a predetermined store according to the identified tendency.

A fourth aspect of the present disclosure relates to a non-transitory storage medium storing instructions that are executable by one or more processors and that cause the one or more processors to perform the following functions. The functions include: acquiring, from a database in which residential areas and electronic payment information of consumers who made electronic payments are recorded in association with each other, the electronic payment information for each of the residential areas; and identifying a tendency of the electronic payments for each of the residential areas based on the electronic payment information for each of the residential areas and determining for each of the residential areas a discount percentage for prices of items for sale at a predetermined store according to the identified tendency.

According to the fourth aspect, the discount percentage is determined for each of the residential areas according to the tendency of the electronic payments for each of the residential areas identified based on the database including the residential areas and the electronic payment information of the consumers who made electronic payments. Accordingly, consumers living in a residential area with a high discount percentage are more motivated to visit the store. According to the above configuration, it is therefore possible to preferentially attract consumers living in a certain area to the store.

In the fourth aspect, a computer configured to determine the discount percentage for each of residential areas of a consumer who is going to purchase the items such that the prices of the items are discounted according to the residential area of the consumer who is going to purchase the items may be caused to perform the functions.

According to each aspect of the present disclosure, the discount percentage determination system, the discounted price presentation system, the discount percentage determination method, and the storage medium can be provided which can preferentially attract consumers living in a certain area to a store.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 illustrates a hardware configuration including a discount percentage determination system, a point of sale (POS) register installed in a store, and a payment server according to an embodiment of the present disclosure;

FIG. 2 is a block diagram illustrating a system configuration of the discount percentage determination system, the POS register, and the payment server;

FIG. 3 is a flowchart of an order acceptance and payment processing process that is executed by the POS register;

FIG. 4 illustrates a license plate of a vehicle;

FIG. 5 illustrates an example of a normal menu displayed on a display of FIG. 1;

FIG. 6 illustrates an example of data in a payment information database;

FIG. 7 is a flowchart of a discount percentage determination process that is executed by the discount percentage determination system;

FIG. 8 illustrates an example of a discount percentage table; and

FIG. 9 illustrates an example of a discounted menu displayed on the display of FIG. 1.

### DETAILED DESCRIPTION OF EMBODIMENTS

An embodiment of the present disclosure will be described with reference to the accompanying drawings.

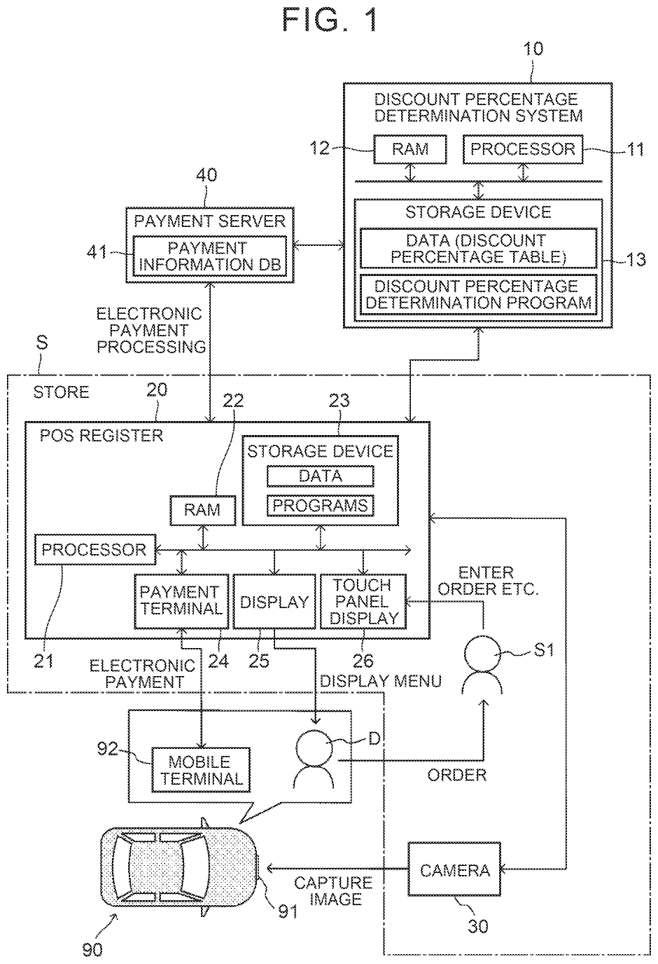

As shown in FIG. 1, a discount percentage determination system 10 according to the embodiment of the present disclosure is configured to communicate with a point of sale (POS) register 20 in a store S. The discount percentage determination system 10 is also configured to communicate with a payment server 40 that communicates with the POS register 20 to process an electronic payment. The discount percentage determination system 10 and the payment server 40 are installed outside the store S and communicate with the POS register 20 via a network such as the Internet, not shown.

The store S is a restaurant that sells food and drink such as hamburgers, and has a drive-through. The store S sells food and drink to a consumer D who comes to the drive-through by a vehicle 90. The consumer D pays for the order by electronic payment using a mobile terminal 92 having an electronic payment function. The electronic payment includes credit card payment and electronic money payment.

The POS register 20 is a device that accepts an order from the consumer D and processes an electronic payment. The POS register 20 includes a processor 21, a random access memory (RAM) 22 that functions as a main memory of the processor 21, and a storage device 23 having stored therein programs and data to be executed or used by the processor 21. The processor 21 is composed of a central processing unit (CPU) etc. and controls the operation of the POS register 20. For example, the storage device 23 is a storage medium such as a flash memory, a hard disk, or a solid-state drive (SSD). The POS register 20 further includes a payment terminal 24 that is used for electronic payment, a display 25 that displays a menu of the store S to the consumer D, and a touch panel display 26 that is operated by an employee S1 of the store S to enter an order etc. received by the employee S1 from the consumer D.

A camera 30 that captures an image of a license plate 91 of the vehicle 90 is also installed in the store S. The camera 30 is controlled by the POS register 20 and supplies the captured image of the license plate 91 to the POS register 20. As will be described in detail later, the captured image is used to identify the residential area of the consumer D.

The payment server 40 communicates with the POS register 20 to process an electronic payment. The payment server 40 has stored therein a payment information database 41. As will be described later, the payment server 40 stores payment information etc. every time it processes an electronic payment, and thus builds and updates the payment information database 41.

The discount percentage determination system 10 determines a discount percentage for food and drink sold at the store S by referring to the payment information database 41 (this will be described in detail later). The discount percentage determination system 10 is composed of a server computer etc. and includes a processor 11, a RAM 12 that functions as a main memory of the processor 11, and a storage device 13 having stored therein a discount percentage determination program and data (including a discount percentage table that will be described later) to be executed or used by the processor 11. The processor 11 is composed of a central processing unit (CPU) etc. For example, the storage device 13 is a storage medium such as a flash memory, a hard disk, or a solid-state drive (SSD).

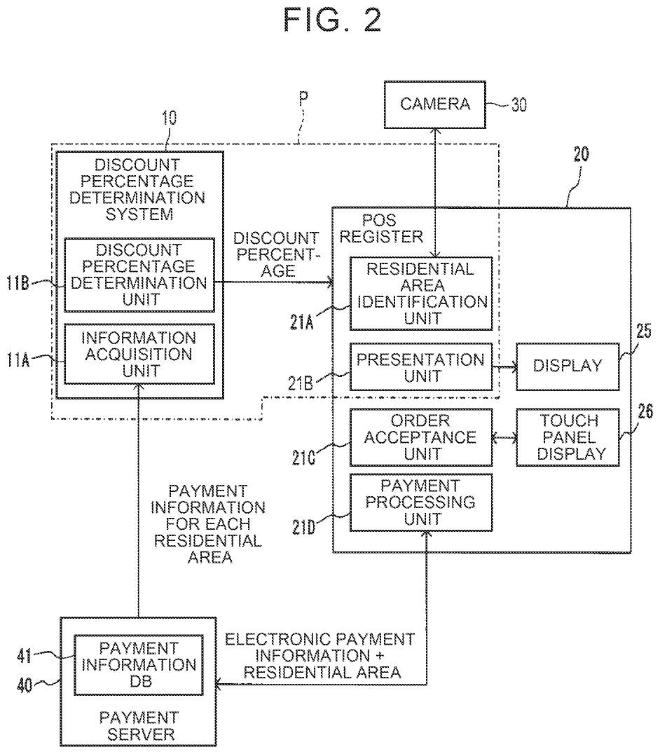

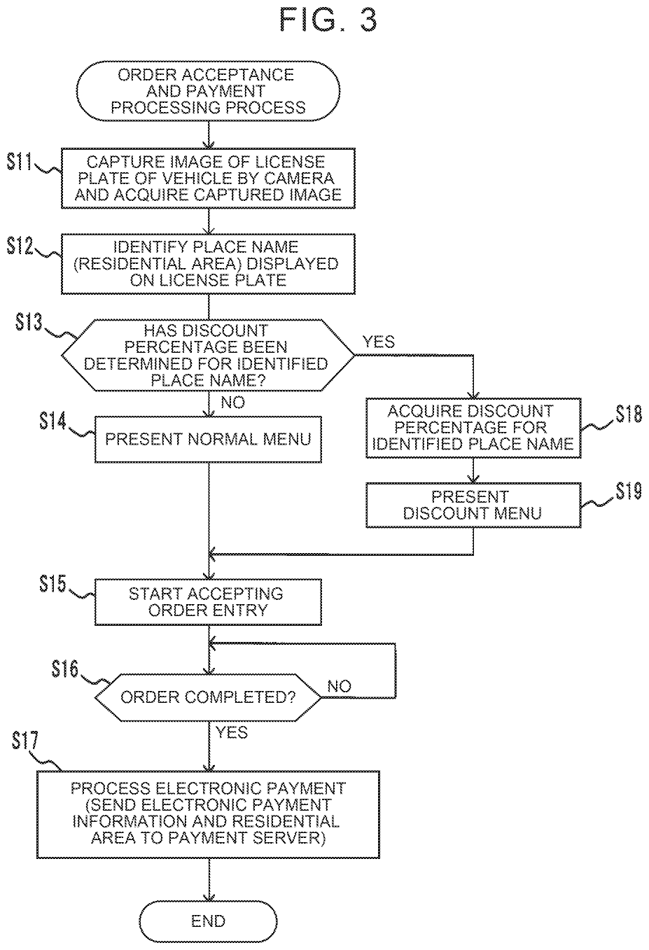

Next, the operation of the POS register 20 will be described. The processor 21 of the POS register 20 operates as a residential area identification unit 21A, a presentation unit 21B, an order acceptance unit 21C, and a payment processing unit 21D shown in FIG. 2 by executing the programs stored in the storage device 23 and using the data stored in the storage device 23. The units 21A to 21D work together to perform an order acceptance and payment processing process shown in FIG. 3. The order acceptance and payment processing process is a process for accepting an order and processing an electronic payment for the order and is also a process for building the payment information database 41.

The order acceptance and payment processing process is started in response to the employee S1 entering on the touch panel display 26 the information that the employee S1 is going to start entering an order when the consumer D comes to the drive-through of the store S by the vehicle 90.

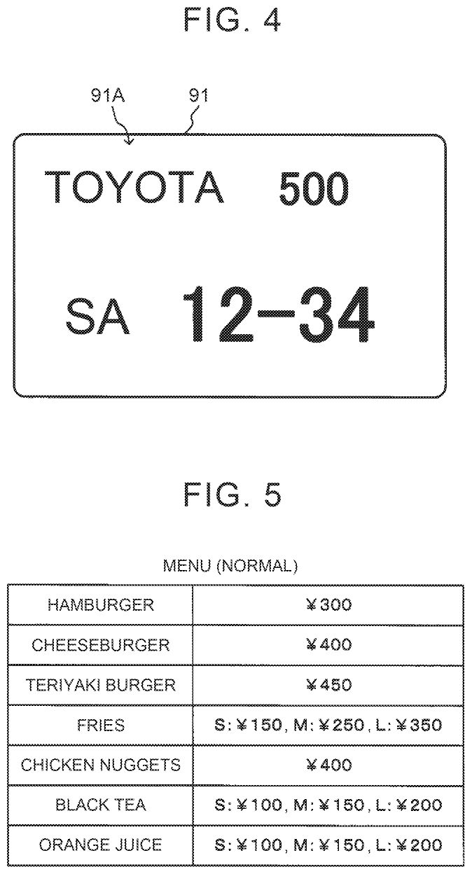

In the order acceptance and payment processing process shown in FIG. 3, the camera 30 first captures an image of the license plate 91 of the vehicle 90, and the residential area identification unit 21A acquires the captured image from the camera 30 (step S11). The residential area identification unit 21A then processes the acquired captured image to identify a place name 91A (see FIG. 4) displayed on the license plate 91 in the captured image (step S12). For example, the residential area identification unit 21A identifies the place name by a process such as pattern matching based on a template image of each place name used for license plates. The place name displayed on the license plate 91 of the vehicle 90 is often a place name corresponding to the address of the consumer D. It can therefore be said that the place name displayed on the license plate 91 of the vehicle is the residential area of the consumer D. Accordingly, the residential area identification unit 21A identifies the residential area of the consumer D by identifying the place name displayed on the license plate 91.

After step S12, the presentation unit 21B communicates with the discount percentage determination system 10 to determine whether the discount percentage determination system 10 has determined a discount percentage for the residential area identified by the residential area identification unit 21A (step S13). The discount percentage is a discount percentage for food and drink sold at the store S. Determination of the discount percentage and a process (steps S18 and S19) that is performed when the discount percentage has been determined (step S13; Yes) will be described later. It is herein assumed that the discount percentage has not been determined.

When the discount percentage has not been determined (step S13; No), the presentation unit 21B presents a normal menu of the store S to the consumer D by displaying the normal menu on the display 25 (step S14). As shown in FIG. 5, the normal menu includes the names, prices, etc. of foods and drinks that can be ordered. The menu may include images of the foods and drinks. The prices included in the normal menu are normal prices, that is, regular prices to which the discount at the above discount percentage has not been applied. The presentation unit 21B thus presents the normal prices of the foods and drinks without discount to the consumer D.

After step S14, the order acceptance unit 21C displays an order entry screen etc. on the touch panel display 26 and starts accepting entry of an order on the touch panel display 26 (step S15). The order acceptance unit 21C then waits until the order entry is completed (step S16).

The consumer D looks at the menu presented by the presentation unit 21B and orders desired food and drink to the employee S1 of the store S. The employee S1 enters the order of the consumer D on the touch panel display 26. When the order entry is completed, the employee S1 enters on the touch panel display 26 the information that the order is completed.

When the order entry is completed (step S16; Yes), the consumer D holds the mobile terminal 92 over the payment terminal 24, so that the payment processing unit 21D communicates with the mobile terminal 92 via the payment terminal 24 to read identification information that identifies the consumer D in an electronic payment, such as a credit card number, from the mobile terminal 92. The payment processing unit 21D then sends as electronic payment information both the identification information and a payment amount that is a total amount of the order received by the order acceptance unit 21C to the payment server 40 and processes the electronic payment for the order (step S17). When sending the electronic payment information, the payment processing unit 21D also sends the residential area of the consumer D (in this example, the place name on the license plate 91) identified by the residential area identification unit 21A to the payment server 40.

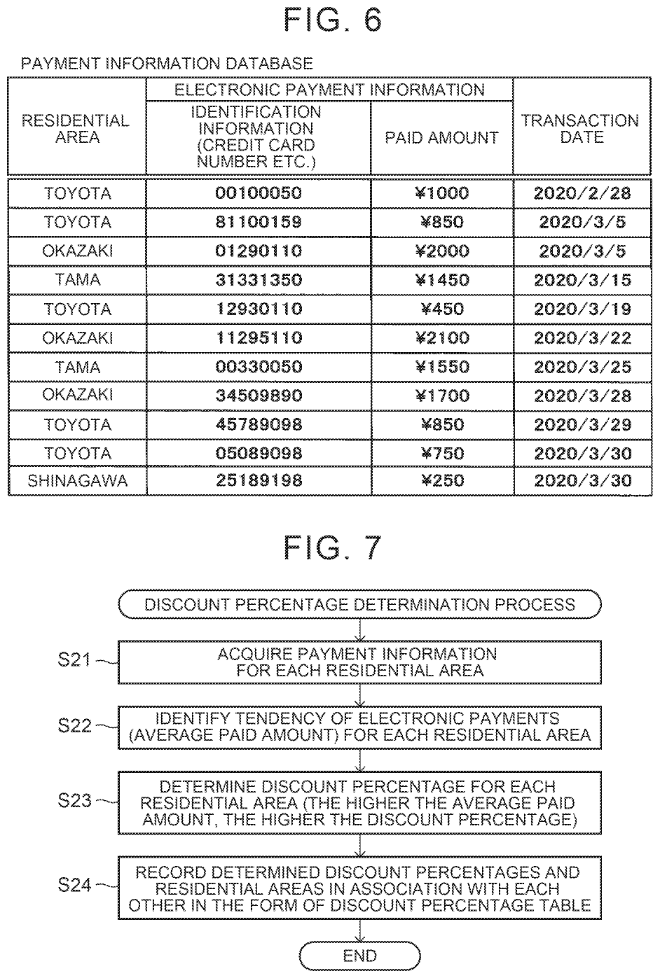

The payment server 40 stores the electronic payment information and the residential area sent from the payment processing unit 21D in association with a current date (hereinafter also referred to as a transaction date). Every time an electronic payment is made, that is, every time the order acceptance and payment processing process is executed, the payment server 40 stores the residential area and the electronic payment information sent from the payment processing unit 21D in association with each other. The payment server 40 thus builds the payment information database 41 in which the residential areas and the electronic payment information of consumers who made an electronic payment are associated with each other. As shown in FIG. 6, the payment information database 41 includes a plurality of residential areas, a plurality of pieces of electronic payment information, and transaction dates associated with each other on a one-to-one basis. The payment information database 41 is configured for electronic payments made at the store S.

Next, the operation of the discount percentage determination system 10 will be described. The processor 11 of the discount percentage determination system 10 operates as an information acquisition unit 11A and a discount percentage determination unit 11B by executing the discount percentage determination program stored in the storage device 13 and using the data stored in the storage device 13. The information acquisition unit 11A and the discount percentage determination unit 11B work together to execute a discount percentage determination process shown in FIG. 7. For example, the discount percentage determination process is executed periodically, such as on the first day of every month.

In the discount percentage determination process, the information acquisition unit 11A first accesses the payment information database 41 to acquire the electronic payment information for each residential area from the payment information database 41 (step S21). In this example, the information acquisition unit 11A acquires electronic payment information for transaction dates within a certain period in the past. As an example, in the case where the current date is Apr. 1, 2020, the certain period is one month, and the payment information database 41 has data shown in FIG. 6, the information acquisition unit 11A individually acquires the following pieces of payment information for the transaction dates on or after Mar. 1, 2020: four pieces of payment information for “Toyota” (payment information in the second, fifth, ninth, and 10th rows from the top), three pieces of payment information for “Okazaki” (payment information in the third, sixth, and eighth rows from the top), two pieces of payment information for “Tama” (payment information in the fourth and seventh rows from the top), and a piece of payment information for “Shinagawa” (payment information in the bottom row).

After step S21, the discount percentage determination unit 11B identifies the tendency of the electronic payments for each residential area based on the electronic payment information for each residential area acquired by the information acquisition unit 11A (step S22). In this example, the tendency of the electronic payments is an average amount paid per electronic payment. Therefore, in step S22, the discount percentage determination unit 11B calculates the average paid amount for each residential area based on the electronic payment information. When the payment information database 41 has the data shown in FIG. 6, the discount percentage determination unit 11B calculates (850+450+850+750)/4=725 yen as the average paid amount for “Toyota.” Similarly, the discount percentage determination unit 11B calculates (2000+2100+1700)/3=about 1933 yen as the average paid amount for “Okazaki” Similarly, the discount percentage determination unit 11B calculates (1450+1550)/2=1500 yen as the average paid amount for “Tama.” The discount percentage determination unit 11B calculates 250/1=250 yen as the average paid amount for “Shinagawa.”

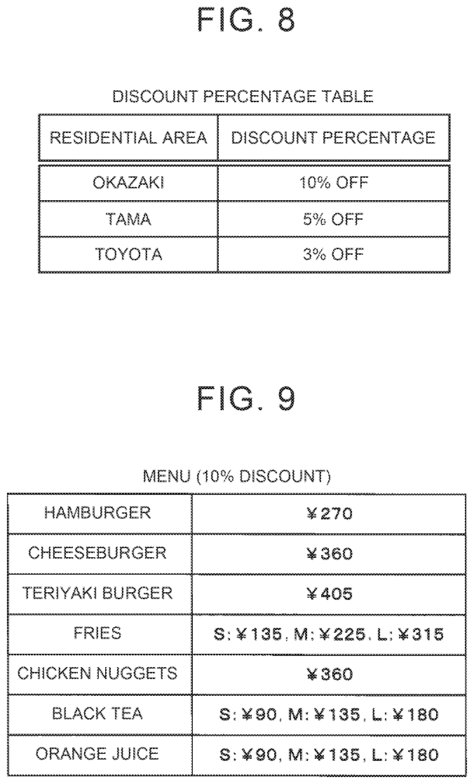

After step S22, the discount percentage determination unit 11B determines a discount percentage for each residential area according to the identified tendency of the electronic payments, as shown in FIG. 8 (step S23). In this example, the discount percentage determination unit 11B determines the discount percentage in such a manner that the higher the average paid amount, the higher the discount percentage. For example, the discount percentage determination unit 11B determines that the discount percentage is 10% for the residential area with the highest average paid amount (“Okazaki” in the example of FIG. 6), 5% for the residential area with the second highest average paid amount (“Tama” in the example of FIG. 6), and 3% for the residential area with the third highest average paid amount (“Toyota” in the example of FIG. 6). It is herein assumed that the discount percentage is not set for the residential areas with the fourth highest and subsequent average paid amounts (“Shinagawa” in the example of FIG. 6).

After step S23, the discount percentage determination unit 11B records in the storage device 13 the residential areas and the discount percentages determined for each residential area in association with each other in the form of a discount percentage table as shown in FIG. 8 (step S24).

Referring back to the flowchart of FIG. 3, in step S13 of the order acceptance and payment processing process of FIG. 3, the presentation unit 21B determines whether the discount percentage determination system 10 has determined a discount percentage for the residential area identified by the residential area identification unit 21A, as described above. In the case where the storage device 13 of the discount percentage determination system 10 has the discount percentage table stored therein and the discount percentage table includes the residential area identified by the residential area identification unit 21A, the presentation unit 21B determines that a discount percentage has been determined for the residential area identified by the residential area identification unit 21A (step S13; Yes) and acquires the discount percentage for this residential area from the discount percentage table in the discount percentage determination system 10 (step S18).

After step S18, the presentation unit 21B presents a discount menu reflecting the prices discounted at the acquired discount percentage to the consumer D by displaying the discount menu on the display 25 (step S19). The routine then proceeds to step S15. As shown in FIG. 9, the discount menu includes the names, prices, etc. of foods and drinks that can be ordered like the normal menu of FIG. 5, but the prices are discounted prices (in FIG. 9, the residential area is “Okazaki” and a 10% discount has been applied). In this way, the presentation unit 21B presents the discounted prices to the consumer D in step S19.

As described above, the discount percentage determination system 10 determines the discount percentage for each residential area in order to discount the prices of items for sale at the store S according to the residential area of the consumer who is going to purchase items at the store S. The discount percentage determination system 10 includes: the information acquisition unit 11A configured to acquire, from the payment information database 41 in which the residential areas and the electronic payment information of consumers who made electronic payments are recorded in association with each other, the electronic payment information for each residential area; and the discount percentage determination unit 11B configured to identify the tendency of the electronic payments for each residential area based on the electronic payment information for each residential area and to determine a discount percentage for each residential area according to the identified tendency. According to this configuration, the discount percentage is determined for each residential area according to the tendency of the electronic payments for each residential area identified based on the payment information database 41. Accordingly, consumers living in a residential area with a high discount percentage (“Okazaki” in the example of FIG. 6) are more motivated to visit the store S. According to the above configuration, it is therefore possible to preferentially attract consumers living in a certain area to the store.

Moreover, in the above configuration, the tendency of the electronic payments is the average amount paid per electronic payment made within a predetermined certain period, and the discount percentage determination unit 11B determines the discount percentage in such a manner that the higher the average paid amount, the higher the discount percentage. It can be said that consumers living in a residential area with a high average paid amount tend to pay a large amount of money per purchase at the store S. Accordingly, setting a high discount percentage for the residential area with a high average paid amount can attract more consumers living in this residential area to the store S and can further increase the sales of the store S. Although the discount percentage determination unit 11B determines the discount percentage according to the average paid amount for each residential area, the discount percentage determination unit 11B may determine the discount percentage according to whether the average paid amount falls within a predetermined numerical value range (the same applies to the case where the discount percentage is determined based on other tendencies of the electronic payments as will be described below).

In the above embodiment, a discounted price presentation system P (see FIG. 2) that presents discounted prices of foods and drinks is composed of the discount percentage determination system 10, the residential area identification unit 21A configured to identify the residential area of the consumer D who is going to purchase food and drink at the store S, and the presentation unit 21B configured to present the prices of foods and drinks discounted at the discount percentage determined for the residential area to the consumer D. According to this configuration, the prices discounted at the discount percentage for the residential area can be presented to the consumer D and the customer D's motivation to purchase at the store S can be improved.

In the above embodiment, the residential area of the consumer is the place name displayed on the license plate 91 of the vehicle 90 of the consumer, and the residential area identification unit 21A identifies the place name by acquiring a captured image of the license plate 91 and processing the captured image. Accordingly, when, for example, purchasing food and drink at the drive-through, the consumer D can be presented with the prices discounted at the discount percentage for the residential area of the consumer D without performing an operation of entering the residential area. The convenience of the consumer D is thus improved.

The configuration of the above embodiment can be modified as appropriate. For example, the discount percentage determination system 10 may have any hardware configuration. The POS register 20 or the payment server 40 may operate as at least a part of the discount percentage determination system 10. Specifically, the processor etc. of the POS register 20 or the payment server 40 may operate as at least a part of the information acquisition unit 11A and the discount percentage determination unit 11B of the discount percentage determination system 10. The discount percentage determination system 10 may be composed of devices housed in one housing or may be a combination of a plurality of devices capable of communicating with each other. The payment information database 41 may be stored in a computer (POS register 20 or other computer) of the store S or the discount percentage determination system 10. In this case, the computer of the store S or the discount percentage determination system 10 acquires electronic payment information and a residential area every time an electronic payment is made, and sequentially stores them. The POS register 20 may present the discount percentage by voice. The store S may be a store that provides a service such as massage. That is, the items for sale at the store S may be services. The mobile terminal 92 may be a credit card, an electronic money card, etc. The display 25 may be changed to a touch panel display etc. and the consumer D may directly operate the touch panel display etc. to enter an order. For example, the employee S1 of the store S may look at the license plate 91 of the vehicle 90 and enter the residential area (place name on the license plate 91) into the POS register 20 (touch panel display 26), and the residential area identification unit 21A may identify the entered residential area as the residential area of the consumer D.

The discount percentage determination unit 11B may determine the discount percentage in such a manner that the smaller the average amount paid per electronic payment made within a certain period, the higher the discount percentage. It can be said that consumers living in a residential area with a small average paid amount tend to pay a small amount of money per purchase at the store S. Accordingly, setting a high discount percentage for the residential area with a small average paid amount can attract more consumers living in this residential area to the store S. This can cover the low purchase amount by the number of consumers visiting the store S and can increase the sales of the store S.

The discount percentage determination unit 11B may identify a total amount paid by electronic payments made within a certain period as the tendency of the electronic payments. The discount percentage determination unit 11B may set the discount percentage in such a manner that the larger the total paid amount, the higher the discount percentage, or the smaller the total paid amount, the higher the discount percentage. It can be said that a residential area with a large total paid amount contributes greatly to the sales of the store S as a whole. Accordingly, setting a high discount percentage for the residential area with a large total paid amount can attract even more consumers living in this residential area to the store S and can further increase the sales of the store S. A residential area with a small total paid amount contributes less to the sales of the store S as a whole. Accordingly, setting a high discount percentage for the residential area with a small total paid amount can attract more consumers living in this residential area to the store S and can increase the sales of the store S.

The discount percentage determination unit 11B may identify the number of electronic payments made within a certain period as the tendency of the electronic payments. In this case, the discount percentage determination unit 11B identifies the number of electronic payments based on the number of pieces of electronic payment information associated with the same residential area in the payment information database 41. In this case, the electronic payment information does not need to include a paid amount. The electronic payment information includes at least a paid amount. However, for example, the electronic payment information may be any information that can identify that an electronic payment was made. The discount percentage determination unit 11B determines the discount percentage in such a manner that the larger the number of electronic payments, the higher the discount percentage, or the smaller the number of electronic payments, the higher the discount percentage. For example, it can be said that consumers living in a residential area with a large number of electronic payments tend to visit the store S more frequently. Accordingly, setting a high discount percentage for the residential area with a large number of electronic payments can further increase the frequency of visits of consumers living in this residential area to the store S and can further increase the sales of the store S. It can also be said that consumers living in a residential area with a small number of electronic payments tend to visit the store S less frequently. Accordingly, setting a high discount percentage for the residential area with a small number of electronic payments can increase the frequency of visits of consumers living in this residential area to the store S and can increase the sales of the store S.

The payment information database 41 may store each piece of electronic payment information for electronic payments made at a plurality of stores in a predetermined area such as one municipality. In this case, the discount percentage determination unit 11B may determine a discount percentage common to the stores. Accordingly, it is possible to preferentially attract consumers living in a certain area to all the stores.

The discount percentage determined by the discount percentage determination unit 11B does not have to be a specific numerical value such as 10%. For example, the discount percentage determination unit 11B may determine discount levels such as “high” (high discount percentage), “medium” (medium discount percentage), and “low” (low discount percentage), and the POS register 20 may determine a specific numerical value of the discount percentage based on the discount level. In the case where the discount percentage determination unit 11B determines a discount level common to a plurality of stores, each store (e.g., the POS register or a computer that controls a POS system) may determine a specific numerical value of the discount percentage based on the discount level. This gives each store a certain degree of flexibility in setting a value of the discount percentage. The relationship between the discount level and the value of the discount percentage can be determined in advance by the store.

A period in which the electronic payment information is collected to build the payment information database 41 may be different from a period in which the discount is applied. For example, the payment information database 41 may be built based on the electronic payment information and residential areas for electronic payments made within a first predetermined period, the discount percentage may be determined based on the payment information database 41, and a discount at the determined discount percentage may be applied in a subsequent second predetermined period. The residential areas collected in the first predetermined period may not be identified from the images of the license plates 91, but may be residential areas registered in advance in association with identification information such as credit card numbers. The residential area of the consumer is not limited to the place name on the license plate, but may be the municipality of the consumer's address. In this case, the residential area can be registered in the payment server 40 etc. in association with identification information such as a credit card number. The residential area of the consumer is thus identified when an electronic payment is made. Alternatively, the consumer D or the employee S1 may directly enter the residential area into the POS register 20 when the consumer D places an order. The electronic payment may be a card payment etc.

What is claimed is:

1. A discount percentage determination system, comprising:
an information acquisition unit configured to acquire, from a database in which residential areas and electronic payment information of consumers who made electronic payments are recorded in association with each other, the electronic payment information for each of the residential areas; and
a discount percentage determination unit configured to identify a tendency of the electronic payments for each of the residential areas based on the electronic payment information for each of the residential areas and to determine, for each of the residential areas, a discount percentage for prices of items for sale at a predetermined store according to the identified tendency.

2. The discount percentage determination system according to claim 1, wherein:
the tendency of the electronic payments is a total or an average of amounts paid by the electronic payments made within a certain period; and
the discount percentage determination unit is configured to determine the discount percentage according to the total or the average.

3. The discount percentage determination system according to claim 1, wherein:
the tendency of the electronic payments is the number of the electronic payments made within a certain period; and
the discount percentage determination unit is configured to determine the discount percentage according to the number of the electronic payments.

4. The discount percentage determination system according to claim 1, wherein the discount percentage determination system is configured to determine the discount percentage for each of residential areas of a consumer who is going to purchase the items such that the prices of the items are discounted according to the residential area of the consumer who is going to purchase the items.

5. A discounted price presentation system, comprising:
the discount percentage determination system according to claim 1;
a residential area identification unit configured to identify a residential area of a consumer who is going to purchase items for sale; and
a presentation unit configured to present the prices of the items discounted at the discount percentage determined for the residential area of the consumer, to the consumer.

6. The discounted price presentation system according to claim 5, wherein:
the residential area of the consumer is a place name displayed on a license plate of a vehicle of the consumer; and
the residential area identification unit is configured to acquire a captured image of the license plate, and process the acquired captured image to identify the place name.

7. A discount percentage determination method, comprising:
acquiring, from a database in which residential areas and electronic payment information of consumers who made electronic payments are recorded in association with each other, the electronic payment information for each of the residential areas; and
identifying a tendency of the electronic payments for each of the residential areas based on the electronic payment information for each of the residential areas and determining for each of the residential areas a discount percentage for prices of items for sale at a predetermined store according to the identified tendency.

8. A non-transitory storage medium storing instructions that are executable by one or more processors and that cause the one or more processors to perform functions comprising:
acquiring, from a database in which residential areas and electronic payment information of customers who made electronic payments are recorded in association with each other, the electronic payment information for each of the residential areas; and
identifying a tendency of the electronic payments for each of the residential areas based on the electronic payment information for each of the residential areas and determining for each of the residential areas a discount percentage for prices of items for sale at a predetermined store according to the identified tendency.

9. The storage medium according to claim 8, wherein a computer configured to determine the discount percentage for each of residential areas of a consumer who is going to purchase the items such that the prices of the items are discounted according to the residential area of the consumer who is going to purchase the items is caused to perform the functions.
